(19) United States
(12) Patent Application Publication
(10) Pub. No.: US 2010/0119827 A1
(43) Pub. Date: May 13, 2010

(54) POLYMER SUBMICRON PARTICLE PREPARATION BY SURFACTANT-MEDIATED PRECIPITATION

(75) Inventors: Nan-Loh Yang, Staten Island, NY (US); Kai Su, Harrison, NJ (US)

Correspondence Address: Research Foundation of the City University of New;c/o Darby & Darby P.C., P.O. Box 770, Church Street Station, New York, NY, 10008-0770, US

(73) Assignee: RESEARCH FOUNDATION OF THE CITY UNIVERSITY OF NEW YORK, New York, NY (US)

(21) Appl. No.: 12/532,871

(22) PCT Filed: Apr. 25, 2007
(86) PCT No.: PCT/US2007/067417

§ 371 Date: Sep. 24, 2009

(51) Int. Cl. B32B 5/16; C08G 69/48

(52) U.S. Cl. 428/402; 525/420

(57) ABSTRACT

The present invention is directed to methods for the fabrication of polymer nanoparticles comprising the addition polymer solutions to aqueous solutions containing surfactants, wherein the concentration of the surfactants in the aqueous solution are lower than the critical micelle concentration of the surfactants. The methods of the present invention provide for the precipitation of uniformly dispersed polymer particles in the submicron size range, preferably from about 5 nm to about 100 nm.

### CROSS-REFERENCE TO PRIOR APPLICATION

This application claims priority to U.S. Provisional Application Ser. No. 60/794,585 filed on Apr. 25, 2006, which is incorporated herein by reference in its entirety.

### FIELD OF THE INVENTION

The present invention generally relates to polymer nanostructures, methods of preparation thereof, their use as fibers, plastics, and coatings, and their use in biological and medical applications.

### BACKGROUND OF THE INVENTION

Polymeric nanostructures (e.g., nanoparticles, nanofibers) have attracted increased attention over the past several years. Compared to conventional bulk polymeric structures of one micron and larger, polymeric nanostructures have improved mechanical strength, greater control of transport properties, material property adjustability, and dimensional stability. Because of these properties, polymeric nanostructures are useful in a variety of applications such as, for example, catalysts, coatings, controlled release devices for pharmaceuticals, biostructural fillers, electronics devices and polymeric composites.

Additionally, hydrophilic polymer nanostructures and, in particular, polyamide (PA) nanostructures typically have a greatly enhanced water absorption capacity compared to their bulk counterparts. Specifically, although the water absorption of bulk nylon fibers is only 10% by weight, nylon nanoparticles provide both improved water absorbing ability and spill and wear resistance due to their greatly increased surface area and the accessibility of water to their submicron void.

Polyamides (PA) are a family of important synthetic materials which have broad applications in biology, chemistry, medicine and engineering, including their use as fibers, plastics, and coatings. [1, 2] Polyamides and, in particular, PA nanostructures are currently being investigated for their promising applications in stem cell cultures and tissue engineering. For example, nylon-6 nanoparticles and nanofibers are now considered ideal biological scaffold materials because of their structural similarity to natural collagen proteins. PA nanoparticles also show promise as alternatives to natural proteins as delivery vehicles for gene/drug therapy.[3-19]

One method for preparing polymeric nanostructures, for example nylon nanostructures, is electrospinning. [20] Using the electrospinning method, nylon nanofibers with different diameters can be obtained by adjusting the processing parameters including the spinning speed and the electrical field. Although electrospinning is currently considered the most effective method for the fabrication of polymer nanofibers, the method has several disadvantages including the need for a high electrical field during processing, and difficulty in performing reactions on an industrial scale.

Additionally, nanoparticles have been formed through miniemulsional polymerization techniques. This process has been successfully applied to the synthesis of poly(ε-caprolactam) and nylon-6 through anionic polymerization of their corresponding monomers. [21] This process, however, provides for in situ polymerization and, thus, is not applicable to commercially available bulk poly(ε-caprolactam) and nylon-6 products.

U.S. Pat. No. 6,143,211 describes a process for preparing polymer nanoparticles. This process consists of forming a mixture of a polymer and a solvent, wherein the solvent is present in a continuous phase and introducing the mixture into an effective amount of non-solvent to cause the spontaneous formation of nanoparticles, including polyamide nanoparticles, through phase inversion. This patent does not speak to the presence of a surfactant.

U.S. Pat. No. 6,6632,671 describes a nanoparticle encapsulation system and method for its production. The invention includes a method of forming a surfactant micelle and dispersing the surfactant micelle into an aqueous composition having a hydrophilic polymer to form a stabilized dispersion of surfactant micelles. The method further includes mechanically forming droplets of the stabilized dispersion of the surfactant micelles, precipitating the hydrophilic polymer to from precipitated nanocapsules, incubating the nanocapsules to reduce a diameter of the nanocapsules, and filtering or centrifuging the nanocapsules. These methods employ surfactant micelles through the use of solutions with surfactant concentrations above the critical micelle concentration (CMC) of the surfactant.

U.S. Pat. No. 6,824,791 describes a method for micronizing a hydrophobic agent such as a drug where the hydrophobic agent is dissolved with the polymer and then precipitated. These methods do not employ a surfactant to form the polymer particles.

As mentioned above, polymer microstructures and nanostructures can be used in a variety of applications. For example, US Publication 2006/019085 and US Publication 2006/019080 disclose a friction material, wherein polymer nanoparticles are used as friction modifiers. WO 2005/104755 discloses the construction of an integrated artificial immune system in which polymer microspheres provide, for example, steady controlled release of encapsulated chemokines. WO 2005/110508 discloses methods for modulating thermal and mechanical properties, and enhancing biocompatibilities of implantable devices by coating the devices with polymer nanoparticles. WO 2005025630 discloses a composition comprising polymeric nanofibers having a diameter of between 100 and 1000 nm, in the form of a medical device, sutures, drug delivery device, matrix or scaffold for tissue engineering, repair, or a regeneration device, medical prosthesis, or cosmetic skin mask.

Due to the aforementioned properties and applications, there is a need for improved methods for the preparation of polymeric nanostructures that are cost-effective, and amenable to synthesis on an industrial scale. In particular, there is a need for methods that allow for bulk polymeric materials to be converted to their corresponding polymeric nanostructures using simple user-friendly laboratory techniques.

### SUMMARY OF THE INVENTION

The novel methods of the present invention for fabricating polymer nanostructures include:

addition of a polymer solution containing one or more solvents and one or more polymers to an aqueous solution containing one or more surfactants, wherein

the concentration of the one or more surfactants in the aqueous solution is below the critical micelle concentration of the surfactants, and wherein

the addition of the polymer solution to the aqueous solution causes the one or more polymers to precipitate as a plurality of polymer nanostructures.

In a further embodiment of the present invention, the methods further comprise separating the plurality of polymer nanostructures from a supertanant comprising the one or more solvents of the polymer solution and water.

In accordance with the present invention, polymer nanostructures are provided prepared by the methods comprising:

addition of a polymer solution containing one or more solvents and one or more polymers to an aqueous solution containing one or more surfactants, wherein

the concentration of the one or more surfactants in the aqueous solution is at least one order of magnitude below the critical micelle concentration of the surfactants, and wherein

the addition of the polymer solution to the aqueous solution causes the one or more polymers to precipitate as a plurality of polymer nanostructures; and

separating the plurality of polymer nanostructures from a supertanant comprising the one or more solvents of the polymer solution and water.

The polymer nanostructures made in accordance with the methods of the present invention can be used in coating applications where the small particle size will enhance the physical properties of the coated products. The polymer nanostructures made in accordance with the methods of the present invention can also be used as water absorbant materials with increased spill resistance, or as lubricants.

In particular embodiments, the polymer nanostructures made in accordance with the methods of the present invention can be used as in vivo scaffold materials due to their chemical and biological similarity to proteins, for example collagen proteins. These particular nanostructures can also be used as a substitute to injectable collagen, in skin grafts, and to improve facial appearance (lines, wrinkles, and scars). In a further embodiment, the polymer nanostructures made in accordance with the methods of the present invention can be used as a substitute for natural proteins in gene/drug delivery systems.

In a particular embodiment, the methods of the present invention can employ biopolymers such as collagen to produce biocompatible nanostructures.

In a further embodiment, the polymer nanostructures made in accordance with the methods of the present invention can be used in conjunction with biopolymers such as collagen to produce biocompatible nanoparticle conjugates. These conjugated materials can be used, for example, as a bone graft substitute, a urinary incontinence treatment, a lenticule, a vascular stent graft, anticancer therapy, and in ear repair, and wound healing.

### BRIEF DESCRIPTION OF THE DRAWINGS

Non-limiting and non-exhaustive embodiments of the present invention are described with reference to the following drawings.

For a better understanding of the present invention, reference will be made to the following Detailed Description, which is to be read in association with the accompanying drawings, wherein:

FIG. 1 depicts an atomic force microscopy (AFM) image of nylon-6 nanoparticles made through the addition of a nylon-6 solution (1 mg/mL) and an aqueous solution containing triton X-100 (0.045 mg/mL). FIG. 1(a) is the topological image. FIG. 1(b) is the phase image of the same measurement. FIG. 1(c) is a section analysis of the height image.

FIG. 2. depicts another AFM image of nylon-6 nanoparticles made through the addition of a nylon-6 solution (1 mg/mL) to an aqueous solution containing triton X-100 (0.045 mg/mL). FIG. 2(a) is the topological image. The white spheres are nylon nanoparticles. The light gray circles are the surfactant assembles. FIG. 2(b) is the phase image of the same measurement. It shows the hardness difference between the nylon nanoparticles and the surfactant assembles. FIG. 2(c) is a section analysis of the height image. The diameter of the particles is in the range of 70-80 nanometers.

FIG. 3. depicts another AFM image of nylon-6 nanoparticles made through the addition of a nylon-6 solution (0.5 mg/mL) to an aqueous solution containing triton X-100 (0.045 mg/mL). FIG. 3(a) is the topological image. The white spheres are nylon nanoparticles. FIG. 3(b) is the phase image of the same measurement. FIG. 3(c) is a section analysis of the height image.

FIG. 4. depicts an AFM image of nylon-6 nanoparticles made through the addition of a nylon-6 solution (0.1 mg/mL) to an aqueous solution containing triton X-100 (0.045 mg/mL). FIG. 4(a) is the topological image. The white spheres are nylon nanoparticles. The large white flakes are the surfactant assembles. FIG. 4(b) is the phase image of the same measurement. It shows the hardness difference between the nylon nanoparticles and the surfactant assembles. Some nanoparticles are free of encapsulation and the others are encapsulated in the surfactant flakes. FIG. 4(c) is a section analysis of the height image.

FIG. 5. depicts an AFM image of nylon-6 nanoparticles made through the addition of a nylon-6 solution (1mg/mL) to an aqueous solution containing CTAB (0.0074 mg/mL). FIG. 5(a) is the topological image. Nylon shows nanorod morphologies. FIG. 5(b) is the phase image of the same measurement. FIG. 5(c) Section analysis of the height image.

FIG. 6. depicts an AFM image of nylon-6 nanoparticles made through the addition of a nylon-6 solution (0.1 mg/mL) to an aqueous solution containing CTAB (0.0074 mg/mL). FIG. 6(a) is the topological image. The little white spheres are nylon nanoparticles. The large dark gray flakes are the surfactant assembles. FIG. 6(b) is the phase image of the same measurement. It shows the hardness difference between the nylon nanoparticles and the surfactant assemblies. Some nanoparticles are free of encapsulation and the others are encapsulated in the surfactant flakes. FIG. 6(c) Section analysis of the height image.

FIG. 7 provides a flow chart for the method of the fabricating nylon-6 nanoparticles. (A) The surfactant solution. (B) Addition of Nylon-6 in formic acid into the surfactant solution at medium level of stirring. (C) The formation of Nylon-6 nanoparticles by surfactant-mediated precipitation.

FIG. 8. depicts a flow chart for one particular embodiment for fabricating nylon-6 nanostructures through the practice of the methods of the present invention.

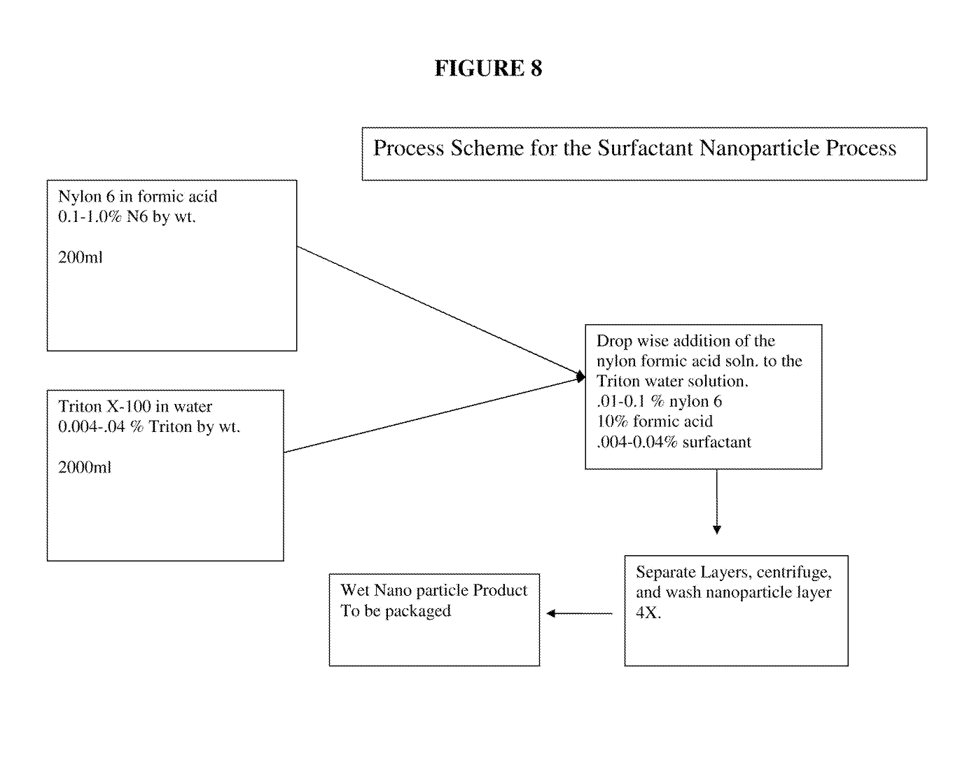

FIG. 9 depicts a flow chart for one particular embodiment for recycling the water, formic acid, and the surfactant used in the fabrication of nylon nanoparticles.

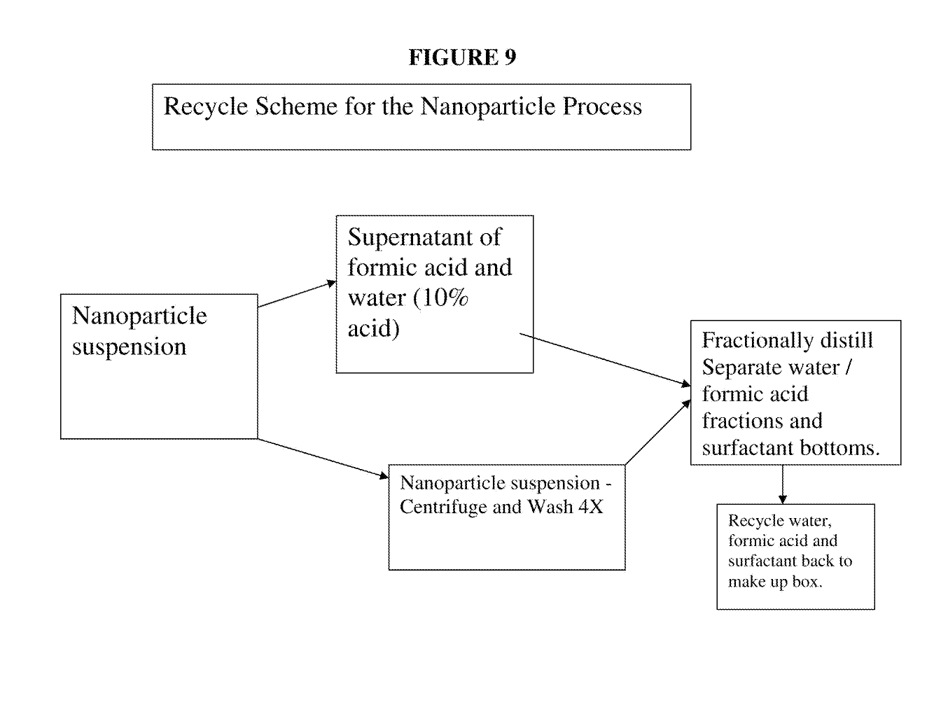

### DETAILED DESCRIPTION OF THE INVENTION

Polymer precipitation through the addition of a polymer solution to a solvent in which the polymer is not soluble (i.e., a “poor solvent”) is a well-developed technique in the field of polymer preparation. In solution polymerization, precipitation is usually employed to facilitate the isolation of the polymer product. For example, in a precipitation polymerization, the polymer product is often soluble in its own monomer but insoluble in the polymerization solvent so, as the polymerization reaction proceeds to conversion, the polymer precipitates from solution. A major drawback to these in situ polymerizations is that the polymer coalesces upon precipitation, and/or creates larger polymer particles through Ostwald ripening (spontaneous processes which act to lower the overall surface energy of the polymer particles). Depending on the species of the polymer and the solvent used, the size of these precipitated polymer particles is typically of micrometer size or larger. Furthermore, coalescence and Ostwald ripening significantly increase the size distribution of the polymer particles. Accordingly, in situ precipitation polymerizations are not capable of fabricating polymer particles with sizes smaller than one micrometer or polymer particles with a narrow size distribution.

Techniques such as dispersion and emulsion polymerizations have been developed for controlling the polymer particle size and the size distribution of particles. However, these polymerization techniques often create colloidal polymer products with sizes typically in the micrometer range and larger. In these polymerizations, polymer particle size is limited by the size of the surfactant micelles in which polymer nucleation occurs. Thus, because micelles typically are in the micrometer size range, the resultant polymer particles are as well.

Recently, submicron-sized polymer structures have been fabricated using in situ microemulsion and miniemulsion polymerization techniques. These techniques have allowed for polymer particles to be formed on the nanometer scale (e.g., 50 to 500 nm) with a narrow size distribution. However, the application of these techniques is currently limited to in situ polycondensation and polyaddition polymerization reactions and cannot be used to produce polymeric nanostructures starting from bulk polymer materials. [21]

Inorganic nanostructures have been fabricated from bulk inorganic materials using surfactant-mediated processes which avoid coalescence and Ostwald ripening. These techniques have been employed to bulk inorganic materials such as zinc oxide, cadmium telluride, and organotitanates. [22-26]

The present invention is based on the discovery that polymer nanostructures can be formed from bulk polymer materials when a solution of the bulk polymer is added to an aqueous solution of surfactant, wherein the surfactant concentration is significantly lower than the critical micelle concentration (CMC) of the surfactant. By employing the methods of the present invention, bulk polymer materials can be converted to polymer nanostructures, preferably of uniform size and shape.

The CMC of a surfactant is the concentration above which micelle assemblies are formed spontaneously, leading to spherical micelles with diameters in the micrometer range. Thus, when micelles are present during a polymerization or when a polymer solution is added to aqueous surfactant solution at or above the CMC, the size of the polymer precipitate particles are also typically of micrometer size or larger. Through the use of an aqueous solution with surfactant concentration significantly lower than the CMC, micelle formation is avoided and most of the surfactant molecules are freely dissolved in water with little to no surfactant associations. The present invention is based on the discovery that, when a polymer solution is added to an aqueous solution with a surfactant concentration significantly lower than the CMC (i.e., an aqueous solution wherein micelles are substantially absent), the previously dissolved bulk polymer precipitates without coalescence or Ostwald ripening and, thus, polymeric nanostructures are formed, preferably, with a narrow size distribution.

### Methods for Fabricating Polymer Nanostructures

The methods of the present invention can be used with any bulk polymer that is caused to precipitate from the polymer solution upon addition to an aqueous solution of surfactant. The term “bulk polymer,” as used in the context of the present invention, refers to polymers that have already been synthesized prior to employing the methods herein. The bulk polymers can be provided from a commercial source, or can be synthesized through any conventional polymerization techniques. The bulk polymers may be non-crosslinked, or lightly or highly crosslinked. Preferred bulk polymers to be used in the methods of the present invention are polyamides, polyacrylates, polyesters, polyethers, and proteins, for example, collagen.

Polyamides are herein to be understood as being homopolymers, copolymers, blends and grafts of synthetic long-chain polyamides having recurring amide groups in the polymer main chain as an essential constituent. Examples of polyamides that are suitable for the practice of the present invention are nylon-6 (polycaprolactam), nylon-6,6 (polyhexamethyleneadipamide), nylon-4,6 (polytetramethyleneadipamide), nylon-6,10 (polyhexamethylenesebacamide), nylon-7 (polyenantholactam), nylon-11 (polyundecanolactam), nylon-12 (polydodecanolactam). As well as polyamides known by the generic name of nylon, polyamides further include the aramids (aromatic polyamides), such as poly-meta-phenyleneisophthalamide and poly-para-phenyleneterephthalamide.

Polyesters suitable for the practice of the present invention include those, which are derived from the condensation of aromatic, cycloaliphatic, and aliphatic diols with aliphatic, aromatic and cycloaliphatic dicarboxylic acids and may be cycloaliphatic, aliphatic or aromatic polyesters. Exemplary of useful cycloaliphatic, aliphatic and aromatic polyesters which can be utilized in the practice of their invention are poly(ethylene terephthalate), poly(cyclohexlenedimethylene), terephthalate) poly(ethylene dodecate), poly(butylene terephthalate), poly(ethylene naphthalate), poly(ethylene(2,7-naphthalate)), poly(methaphenylene isophthalate), poly(glycolic acid), poly(ethylene succinate), poly(ethylene adipate), poly(ethylene sebacate), poly(decamethylene azelate), poly(ethylene sebacate), poly(decamethylene adipate), poly(decamethylene sebacate), poly(dimethylpropiolactone), poly(para-hydroxybenzoate), poly(ethylene oxybenzoate), poly(ethylene isophthalate), poly(tetramethylene terephthalate, poly(hexamethylene terephthalate), poly(decamethylene terephthalate), poly(1,4-cyclohexane dimethylene terephthalate) (trans), poly(ethylene 1,5-naphthalate), poly(ethylene 2,6-naphthalate), poly(1,4-cyclohexylene dimethylene terephthalate) (cis), and poly(1,4-cyclohexylene dimethylene terephthalate (trans) and copolymers and/or mixtures thereof.

Polyethers suitable for the practice of the present invention include, for example, polyoxyalkyl derivatives of glycols and triols such as 1,4-butanediol, 1,4-cyclohexanediol, glycerine, 1,2,6-hexanetriol, trimethylolpropane and pentaerythritol. Other polyethers include the polyoxyalkylene derivatives of glycols and triols such as propylene glycol, diethylene glycol, ethylene glycol, triethylene glycol, 1,3-butylene glycol and 1,4-butylene glycol. The polyoxyalkyl derivatives of bisphenols, halogenated bisphenols, polytetrahydrofurans and isomers of dihydroxybenzeneacetic acid may also be used.

Polyacrylates suitable for the practice of the present invention include polyacrylic acids, polymethacrylic acids, and polyacrylic ethers, for example, poly(methyl methacrylate), poly(ethyl methacrylate), ply(butyl methacrylate), poly(isobutyl methacrylate), poly(hexyl methacrylate), poly(isodecyl methacrylate), poly(lauryl methacrylate), poly(phenyl methacrylate), poly(methyl acrylate), poly(isopropyl acrylate), poly(isobutyl acrylate) and poly(octadecyl acrylate).

In a more preferred embodiment, the bulk polymers are polyamides and collagen. The most preferred bulk polymer is nylon-6.

In an alternative embodiment, the polymers employed in the practice of the methods of the present invention include condensation polymers of polyurethanes, polysilioxanes, polysulfides, and polyacetals; addition polymers including polyolefins, PAN, PVC and other chloro polymers, polystyrene, polyarylates, polyvinyl acetate, PTFE and other fluoropolymers, and rubbers (e.g., polyisoprene).

In a preferred embodiment, the bulk polymer is dissolved in a solvent that is miscible with water so that the addition of the polymer solution to the aqueous solution creates monophasic solution with the resultant precipitation of the polymer nanostructures. Typically, the bulk polymer is added to the solvent and the mixture is stirred until the polymer is completely dissolved. Solvents that are miscible with water include, but are not limited to, formic acid, acetic acid and other organic acids; inorganic acids such as sulfuric acid, hydrochloric acid, nitric acid and phosphoric acid; dimethylformamide, dimethylacetamide, tetrahydrofuran, dioxane, methanol, ethanol, ethylene glycol, and propylene glycol. In a more preferred embodiment, the solvent is an acid. In the most preferred embodiment, the solvent is formic acid.

The concentration of the bulk polymer in the solvent can be any polymer concentration; however, this upper limit to the concentration will be limited by the maximum solubility of the polymer in the solvent. The concentration of the bulk polymer in the solvent is typically from about 0.01 mg/mL to about 100 mg/mL, preferably from about 0.1 mg/mL to about 20 mg/mL, most preferably from about 1 mg/mL to about 10 mg/mL.

The surfactant employed in the methods of the present invention can be any surfactant including, but not limited to, non-ionic surfactants, cationic surfactants, anionic surfactants, amphoteric surfactants, and zwitterionic surfactants. Suitable surfactants are described in McCutcheon's, Detergents and Emulsifiers, North American edition (1986), published by allured Publishing Corporation; and McCutcheon's, Functional Materials, North American Edition (1992).

Any nonionic surfactant is suitable for the methods of the present invention, including, compounds produced by the condensation of alkylene oxide groups with an organic hydrophobic compound which may be aliphatic or alkyl aromatic in nature. Examples of useful nonionic surfactants include the polyethylene, polypropylene, and polybutylene oxide condensates of alkyl phenols; fatty acid amide surfactants, polyhydroxy fatty acid amide surfactants, amine oxide surfactants, alkyl ethoxylate surfactants, alkanoyl glucose amide surfactants, and alkylpolyglycosides. Specific examples of suitable nonionic surfactants include the Triton series surfactants, such as the Triton X series octylphenol ethoxylate surfactants; alkanolamides such as cocamide DEA, cocamide MEA, cocamide MIPA, PEG-5 cocamide MEA, lauramide DEA, and lauramide MEA; alkyl amine oxides such as lauramine oxide, cocamine oxide, cocamidopropylamine oxide, and lauramidopropylamine oxide; sorbitan laurate, sorbitan distearate, fatty acids or fatty acid esters such as lauric acid, isostearic acid, and PEG-150 distearate; fatty alcohols or ethoxylated fatty alcohols such as lauryl alcohol, laureth-4, laureth-7, laureth-9, laureth-40, trideceth alcohol, C11-15 pareth-9, C12-13 Pareth-3, and C14-15 Pareth-11, alkylpolyglucosides such as decyl glucoside, lauryl glucoside, and coco glucoside.

Cationic surfactants suitable for the methods of the present invention, including, for example, amine salts and quaternary ammonium compounds. Some examples of cationic amine salts include polyethoxylated oleyl/stearyl amine, ethoxylated tallow amine, cocoalkylamine, oleylamine, and tallow alkyl amine. For quaternary ammonium compounds (generally referred to as quats) the four groups bonded to the amine may be the same or different organic groups, but may not be hydrogen. In one embodiment the organic groups are branched or linear alkyl or alkene groups which may contain additional functionality such as, for example, fatty acids or derivatives thereof, including esters of fatty acids and fatty acids with alkoxylated groups; alkyl amido groups; aromatic rings; heterocyclic rings; phosphate groups; epoxy groups; and hydroxyl groups. The nitrogen atom may also be part of a heterocyclic or aromatic ring system, e.g., cetethyl morpholinium ethosulfate or steapyrium chloride.

Suitable anions include, for example, chloride, bromide, methosulfate, ethosulfate, lactate, saccharinate, acetate or phosphate, and mixtures thereof.

Examples of quaternary ammonium compounds of the monoalkyl amine derivative type include: cetyl trimethyl ammonium bromide (also known as CTAB or cetrimonium bromide), cetyl trimethyl ammonium chloride (also known as cetrimonium chloride), myristyl trimethyl ammonium bromide (also known as myrtrimonium bromide or Quaternium-13), stearyl dimethyl benzyl ammonium chloride (also known as stearalkonium chloride), oleyl dimethyl benzyl ammonium chloride, (also known as olealkonium chloride), lauryl/myristryl trimethyl ammonium methosulfate (also known as cocotrimonium methosulfate), cetyl-dimethyl-(2)hydroxyethyl ammonium dihydrogen phosphate (also known as hydroxyethyl cetyidimonium phosphate), bassuamidopropylkonium chloride, cocotrimonium chloride, distearyldimonium chloride, wheat germ-amidopropalkonium chloride, stearyl octyidimonium methosulfate, isostearaminopropal-konium chloride, dihydroxypropyl PEG-5 linoleaminium chloride, PEG-2 stearmonium chloride, Quaternium 18, Quaternium 80, Quaternium 82, Quaternium 84, behentrimonium chloride, dicetyl dimonium chloride, behentrimonium methosulfate, tallow trimonium chloride and behenamidopropyl ethyl dimonium ethosulfate.

Quaternary ammonium compound of the dialkyl amine derivative type distearyldimonium chloride, dicetyl dimonium chloride, stearyl octyldimonium methosulfate, dihydrogenated palmoylethyl hydroxyethylmonium methosulfate, dip almitoylethyl hydroxyethylmonium metho sulfate, dioleoylethyl hydroxyethylmonium methosulfate, hydroxypropyl bisstearyldimonium chloride, and mixtures thereof.

Quaternary ammonium compounds of the imidazoline derivative type include, for example, isostearyl benzylimidonium chloride, cocoyl benzyl hydroxyethyl imidazolinium chloride, cocoyl hydroxyethylimidazolinium PG-chloride phosphate, Quaternium 32, and stearyl hydroxyethylimidonium chloride, and mixtures thereof.

Any anionic surfactant is suitable for the methods of the present invention, including, for example, linear alkylbenzene sulfonates, alpha olefin sulfonates, paraffin sulfonates, alkyl ester sulfonates, alkyl sulfates, alkyl alkoxy sulfates, alkyl sulfonates, alkyl alkoxy carboxylates, alkyl alkoxylated sulfates, monoalkyl phosphates, dialkyl phosphates, sarcosinates, isethionates, and taurates, as well as mixtures thereof. Commonly used anionic surfactants that are suitable as the anionic surfactant component of the composition of the present invention include, for example, ammonium lauryl sulfate, ammonium laureth sulfate, triethanolamine laureth sulfate, monoethanolamine lauryl sulfate, monoethanolamine laureth sulfate, diethanolamine lauryl sulfate, diethanolamine laureth sulfate, lauric monoglyceride sodium sulfate, sodium lauryl sulfate, sodium laureth sulfate, potassium lauryl sulfate, potassium laureth sulfate, sodium trideceth sulfate, sodium tridecyl sulfate, ammonium trideceth sulfate, ammonium tridecyl sulfate, sodium cocoyl isethionate, disodium laureth sulfosuccinate, sodium methyl oleoyl taurate, sodium laureth carboxylate, sodium trideceth carboxylate, sodium-monoalkyl phosphates, sodium dialkyl phosphates, sodium lauryl sarcosinate, lauroyl sarcosine, cocoyl sarcosinate, ammonium cocyl sulfate, sodium cocyl sulfate, potassium cocyl sulfate, monoethanolamine cocyl sulfate, sodium tridecyl benzene sulfonate, sodium dodecyl benzene sulfonate, and branched anionic surfactants, such as sodium trideceth sulfate, sodium tridecyl sulfate, ammonium trideceth sulfate, and ammonium tridecyl sulfate.

The cation of any anionic surfactant is typically sodium but may alternatively be potassium, lithium, calcium, magnesium, ammonium, or an alkyl ammonium having up to 6 aliphatic carbon atoms including isopropylammonium, monoethanolammonium, diethanolammonium, and triethanolammonium. Ammonium and ethanolammonium salts are generally more soluble that the sodium salts. Mixtures of the above cations may be used.

Any zwitterionic surfactant is suitable for the methods of the present invention, including, for example, those which can be broadly described as derivatives of aliphatic quaternary ammonium, phosphonium, and sulfonium compounds in which the aliphatic radicals can be straight chain or branched and wherein one of the aliphatic substituents contains from about 8 to 18 carbon atoms and one contains an anionic water-solubilizing group such as carboxyl, sulfonate, sulfate, phosphate or phosphonate. Specific examples of suitable Zwitterionic surfactants include alkyl betaines, such as cocodimethyl carboxymethyl betaine, lauryl dimethyl carboxymethyl betaine, lauryl dimethyl alpha-carboxy-ethyl betaine, cetyl dimethyl carboxymethyl betaine, lauryl bis-(2-hydroxy-ethyl)carboxy methyl betaine, stearyl bis-(2-hydroxy-propyl)carboxymethyl betaine, oleyl dimethyl gamma-carboxypropyl betaine, and lauryl bis-(2-hydroxypropyl)alpha-carbox-yethyl betaine, amidopropyl betaines, and alkyl sultaines, such as cocodimethyl sulfopropyl betaine, stearyidimethyl sulfopropyl betaine, lauryl dimethyl sulfoethyl betaine, lauryl bis-(2-hydroxy-ethyl)sulfoprop-yl betaine, and alkylamidopropylhydroxy sultaines.

Any amphoteric surfactant is suitable for the methods of the present invention, including, for example, derivatives of aliphatic secondary and tertiary amines in which the aliphatic radical can be straight chain or branched and wherein one of the aliphatic substituents contains from about 8 to about 18 carbon atoms and one contains an anionic water solubilizing group. Specific examples of suitable amphoteric surfactants include the alkali metal, alkaline earth metal, ammonium or substituted ammonium salts of alkyl amphocarboxy glycinates and alkyl amphocarboxypropionates, alkyl amphodipropionates, alkyl amphodiacetates, alkyl amphoglycinates, and alkyl amphopropionates, as well as alkyl iminopropionates, alkyl iminodipropionates, and alkyl amphopropylsulfonates, such as for example, cocoamphoacetate cocoamphopropionate, cocoamphodiacetate, lauroamphoacetate, lauroamphodiacetate, lauroamphodipropionate, lauroamphodiacetate, cocoamphopropyl sulfonate caproamphodiacetate, caproamphoacetate, caproamphodipropionate, and stearoamphoacetate.

In a preferred embodiment, the surfactant used in the practice of the methods of the invention is a cationic or a non-ionic surfactant. In a more preferred embodiment, the surfactant is polyoxyethylene octyl phenyl ether (TritonX-100) or cetyl trimethylammonium bromide (CTAB).

The concentration of the surfactant in the aqueous solution is from the CMC of the surfactant, to about 200 times lower than the CMC of the surfactant, preferably from about 2 times lower than the CMC to about 100 times lower that the CMC, more preferably from about 10 times lower than the CMC to about 100 times lower than the CMC. In an alternative embodiment, The concentration of the surfactant in the aqueous solution is preferably from about 2 times lower than the CMC of the surfactant, to about 50 times lower than the CMC of the surfactant, preferably from about 10 to about 50 times lower than the CMC of the surfactant, more preferably from about 25 to about 50 times lower than the CMC. In yet another alternative embodiment, the concentration of the surfactant in the aqueous solution is preferably from about 50 times lower than the CMC of the surfactant, to about 200 times lower than the CMC of the surfactant, preferably from about 50 times lower than the CMC of the surfactant, to about 100 times lower than the CMC of the surfactant, and more preferably, from about 50 times lower than the CMC of the surfactant to about 75 times lower than the CMC of the surfactant The CMC for a surfactant can be determined according to, for example, Rosen, M. J. (2004) Surfactant and Interfacial Phenomena, 3^{rd} edn, Wiley, New York and Mukerjee, P. and Mysels, K. J. (1971) and Critical Micelle Concentration of Aqueous Surfactant Systems, NSRDS-NBS 36, Washington DC. For example, when Triton X-100 is employed in the practice of the methods herein, the concentration in aqueous solution is preferably from about 0.45 mg/mL to about 0.0225 mg/mL, more preferably from about 0.45 mg/mL to about 0.045 mg/mL.

The methods of the present invention are preferably carried out at room temperature and under ambient conditions (i.e. standard temperature and pressure). In a typical experiment, the polymer is pre-dissolved in a solvent, and the surfactant is added to water to achieve a concentration significantly lower than the CMC. The aqueous solution of surfactant is preferably stirred or agitated and the polymer solution is preferably added dropwise to the aqueous solution over time. Addition of the polymer solution to the aqueous solution causes the dissolved polymer to precipitate from solution as nanoparticles. Once addition of the polymer solution is complete, the combined aqueous suspension of water, polymer solvent, surfactant, and polymer nanostructures is preferably stirred for from about 1 to about 48 hours, most preferably for about 24 hours. The suspension is then preferably allowed to settle to form a two layered mixture of precipitated polymer nanostructures and aqueous supertanant. The polymer nanostructures can then be removed from the supertanant through conventional methods, including centrifugation and filtration, preferably centrifugation.

Without wishing to be bound to any particular theory, it is believed that the methods of the present invention allow for the formation of precipitate polymer nuclei with free surfactants absorbed thereon. Because the surfactant is adsorbed on the surface of these tiny particles, coalescence and Ostwald ripening are prevented.

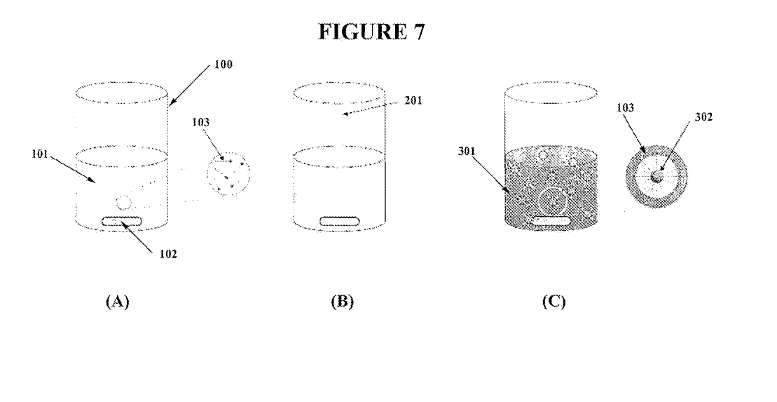

FIG. 7 illustrates an example of the process of controlled precipitation using the methods of the present invention to form polymeric nanostructures. To a container 100 equipped with a stirring mechanism 102, is added an aqueous solution of surfactant 101 (FIG. 7(a)). The concentration of the surfactant is significantly lower than the CMC so that the surfactant molecules do not spontaneously form micelles but, instead, are unassociated in solution (103). To aqueous solution 101 is added the polymer solution 201 through dropwise addition (FIG. 7(b)). Addition of polymer solution 201 to the aqueous solution of surfactant 101 causes the formation of precipitate nuclei of the polymer 302 with surfactant molecules 103 adsorbed to their surfaces, along with an aqueous supertanant 301 ((FIG. 7(c)).

### The Polymer Nanostructures of the Present Invention.

The polymer nanostructures that are fabricated through the practice of the aforementioned methods are precipitated in various morphologies depending on the nature of the polymer, the nature of the surfactant, the concentrations of each in the solution, and the method of addition of the polymer solution to the aqueous surfactant solution. The nanostructures may be of regular or irregular shape, and in the form of, for example, nanofibers or nanoparticles, preferably nanoparticles.

The nanoparticles fabricated according to the methods herein can be irregularly shaped, for example, particles with jagged edges of ill-defined shape and orientation, or can be in the form of regularly shaped geometrical patterns including, but not limited to, spheres, spheroids, and rods.

The nanostructures, preferably nanoparticles, fabricated according to the methods herein have a size in the range of from about 1 nm to about 1000 nm, preferably from about 5 nm to about 500 nm, more preferably from about 5 nm to about 100 nm, and even more preferably, from about 5 nm to about 50 nm.

Additionally, the plurality of nanostructures fabricated according to the methods herein preferably have overall narrow size distribution. The term “narrow size distribution,” as used herein, means that the plurality of nanoparticles formed when performing the methods herein are each of substantially similar size. Size distribution can be determined by, for example, histogram analysis of the statistical distribution of particle sizes from AFM images.

The size of the nanostructures fabricated using the methods of the present invention can be controlled through the choice of polymer, solvent, and surfactant, and, more importantly, the concentration of the polymer in the solvent, the concentration of the surfactant in the aqueous solution, and the scale on while the precipitation methods are performed. For example, when using a nylon-6/formic acid solution and an aqueous solution containing the surfactant Triton X-100, the size of the nanostructures can be controlled by adjusting the concentration of nylon-6 in the formic acid and the concentration of Triton X-100 in aqueous solution. In a preferred embodiment, when the concentration of the polymer is increased while surfactant concentration is held constant, the size of the nanostructures formed increases. Other variables which can be modified in order to control particle size are, for example, reaction temperature, stirring type and motion, rate of addition of the polymer solution, and method of addition of the polymer solution.

The size, size distribution, and shape of the nanostructures can be determined using, for example, atomic force microscopy (AFM). AFM is now widely used for imaging nanometer-sized materials. Beyond imaging, AFM provides useful information for samples at ambient conditions (STP). In addition to the morphological analysis, the phase images are usually used for distinguishing soft and hard materials through phase imaging. For example, inorganic nanoparticles are capable of being differentiated from their peptide templates by the phase image analysis. [27] To determine the morphology of the nanoparticles fabricated according to the foregoing examples, both height and phase images were analyzed.

Without further elaboration, it is believed that one skilled in the art can, using the preceding description, utilize the present invention to its fullest extent. The following examples are, therefore, to be construed as merely illustrative, and not limitative of the remainder of the disclosure in any way whatsoever.

### Examples

### Materials:

Nylon-6, formic acid (99%), Triton X-100, and cetyl trimethylammonium bromide (CTAB) were purchased from Aldrich and used as received.

### General Procedures:

### 1. Preparation of Nylon-6 Solution in Formic Acid:

Nylon-6 pellets were weighed in a 20-mL scintillation vial. In the following examples, 0.200 g, 1.000 g, 2.000 g and 4.000 g were used for each experiment according to the polymer solution concentration desired. The pellets were each transferred to a separate 500 mL round flask. To each flask was added 200 ml of formic acid (99%) to make stock solutions of nylon-6 in formic acid with concentrations of 1 mg/ml, 5 mg/ml, and 10 mg/ml, respectively. The solutions were then stirred until the pellets became completely dissolved (the 1 mg/ml took ˜30 minutes, 5 mg/ml˜90 min and 10 mg/ml˜120 min)

2a. Preparation of Triton X-100 in DI-Water:

Triton X-100 aqueous solutions were prepared in concentrations 0.0225 mg/mL, 0.045 mg/mL, 0.225 mg/mL and 0.450 mg/mL by addition of the appropriate amounts of Triton X-100 to 2L of fresh DI-water in 5-L round bottom flasks with continuous stirring.

2b. Preparation of CTAB in DI-Water:

A CTAB aqueous solutions was prepared with a concentration 0.0074 mg/mL by addition of the appropriate amount of CTAB to 2L of fresh DI-water in 5-L round bottom flasks with continuous stirring.

3a. Addition of Nylon-6 Solution to Triton X-100 Surfactant Solution:

Nanoparticle fabrication experiments using Triton X-100 were carried out on both large and small scale to determine how the size of the reaction affected particle size.

For each large scale experiment, 200 mL of the appropriate nylon-6/formic stock solution was transferred to a 250-ml addition funnel. The nylon 6 solution was then added dropwise to the 5-L round bottom flask containing the appropriate concentration of Triton X-100 in DI-water with constant stirring. Addition of the nylon-6 solution took ˜3 hours to add it drop-wise. The total reaction mixture was a cloudy suspension of 2.2L. Constant stirring was maintained for ˜24 hours.

For each small scale experiment, 10 mL of the appropriate Triton X-100 stock solution was transferred to a 20-mL vial. In this vial, under stirring, was introduced 1 mL of the appropriate nylon-6/formic acid solution. Constant stirring was maintained for 30 minutes.

Because the concentration of TX-100 was much lower than the CMC, the surfactants were freely dissolved in water with no large associations. As soon as the nylon-6 solution was added into the surfactant solution, the precipitation nuclei were immediately apparent. Without wishing to be bound to any particular theory, it is believed that, at this moment, the surfactant molecules were adsorbed onto the nascent nanoparticles to reduce the surface energies.

3b. Addition of Nylon-6 Solution to CTAB Surfactant Solution:

Nanoparticle fabrication experiments using CTAB were carried out on small scale as follows:

10 mL of the CTAB stock solution was transferred to a 20-mL vial. In this vial, under stirring, was introduced 1 mL of the appropriate nylon-6/formic acid solution. Constant stirring was maintained for 30 minutes.

### 4. Polymer Isolation and Atomic Force Microscope (AFM) Measurements:

Each large scale suspension was transferred to large container and allowed to settle for ˜24 hours. The upper supertanant layer (clear color) was pumped out while lower layer (fine white particles) were centrifuged and washed ˜4 times with DI-water to obtain a white, cake-like product. For the AFM sample preparation, each sample solution was 5 times diluted in DI water

Each small scale suspension was 5 times diluted in DI water and used directly in the AFM measurements.

Using a 1 mL syringe and a 200nm PTFE filter, one drop of the sample solution was applied onto a newly cleaved mica surface (0.9 cm disk, Ted Pella) with spin-coating (Headway Research) at 2000 rpm for 30 sec. A picoscan atomic force microscope (Molecular Imaging) was used for all the measurements.

### Example 1

### Nylon-6/Formic Acid Additions to Aqueous Triton X-100 Solutions

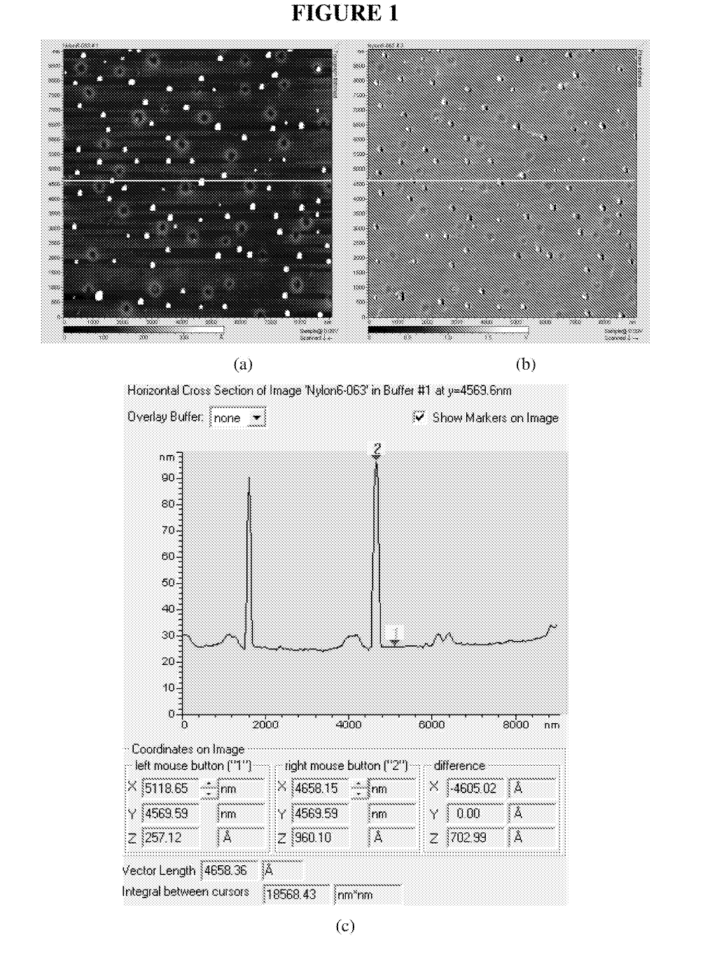

FIGS. 1-4 are the AFM images of isolated nanoparticles prepared from the small scale additions of different concentrations of nylon-6 in formic acid (i.e., 0.1, 0.5, and 1.0 mg/mL concentrations) to an aqueous Triton X-100 solution with a concentration of 0.045 mg/mL, following the aforementioned general procedures. By varying the nylon-6 concentration, different sized nanoparticles were fabricated.

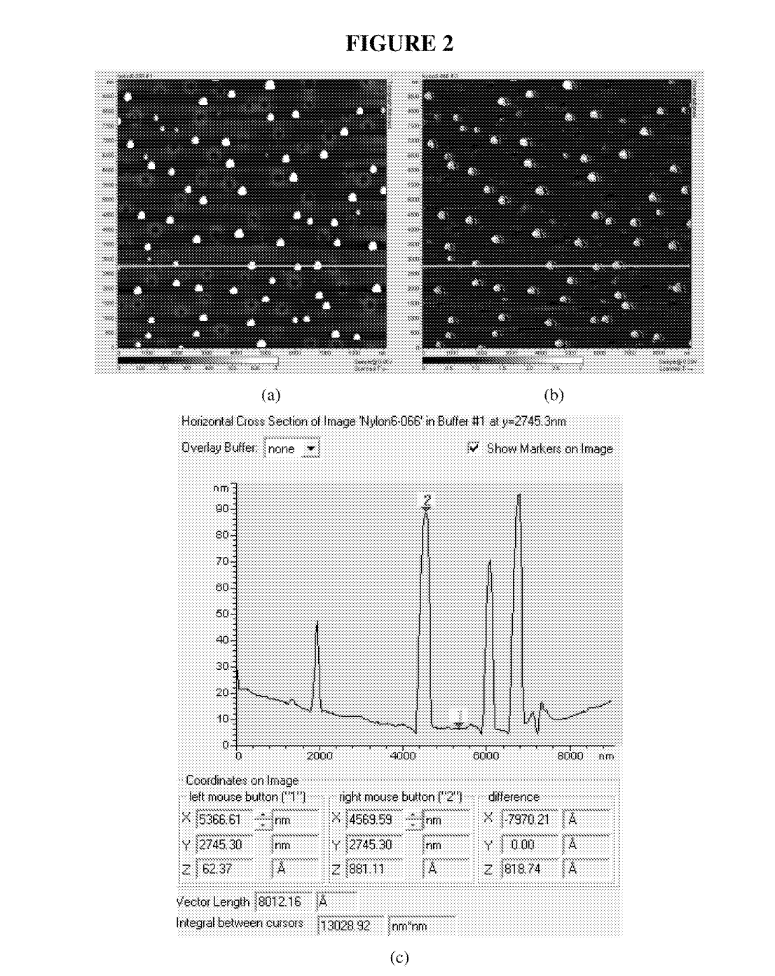

At C_{Nylon}=1 mg/mL (small scale), there were two different types of nanoparticle morphologies formed as shown in FIGS. 1 and 2. FIGS. 1(a) and 2(a) are the topological images. The white spheres are nylon monodispersed nanoparticles and the light grey circles are the surfactant assemblies. The nanorings shown the figures are the surfactant nanoassemblies formed during the controlled precipitation process. As shown in the figures, the nanoparticles are not located inside the nanorings. FIGS. 1(b) and 1(b) are the phase images of the same measurements. They show the hardness difference between the nylon nanoparticles and the surfactant assembles. This binary type morphology is due to the formation of a nanoassembly during the surfactant-mediated precipitation process. FIGS. 1(c) and 2(c) are section analyses providing a height image of the corresponding topographical images. As shown in Table 1, the addition of a 1 mg/mL nylon solution to the Triton X-100 surfactant solution produced substantially spherical nanoparticles with a size of approximately 70-80 nm.

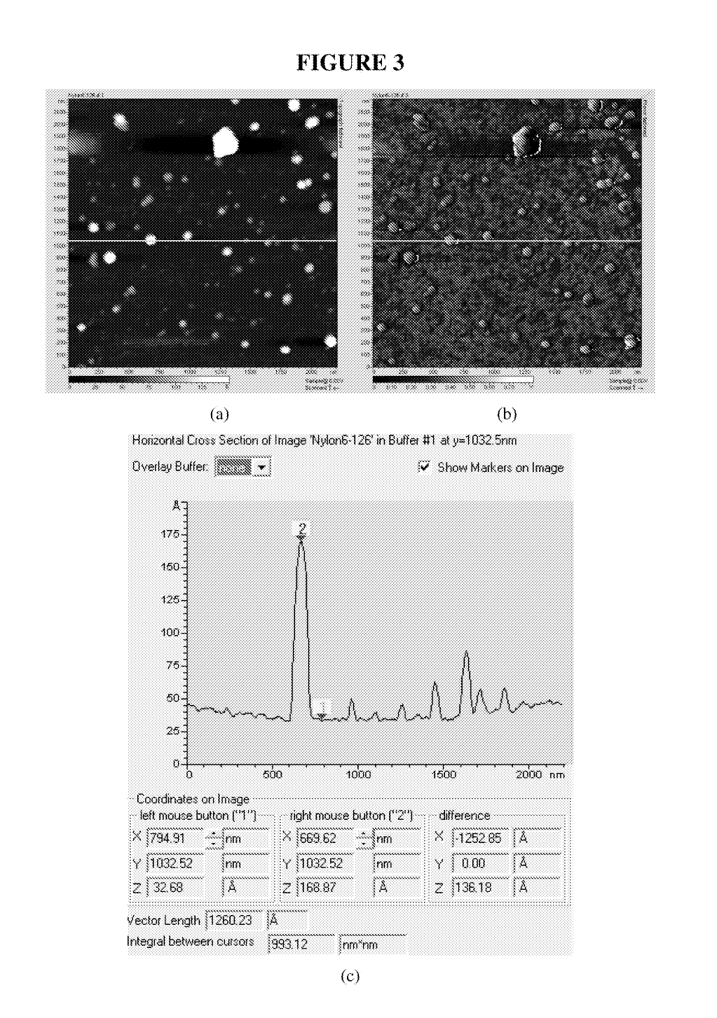

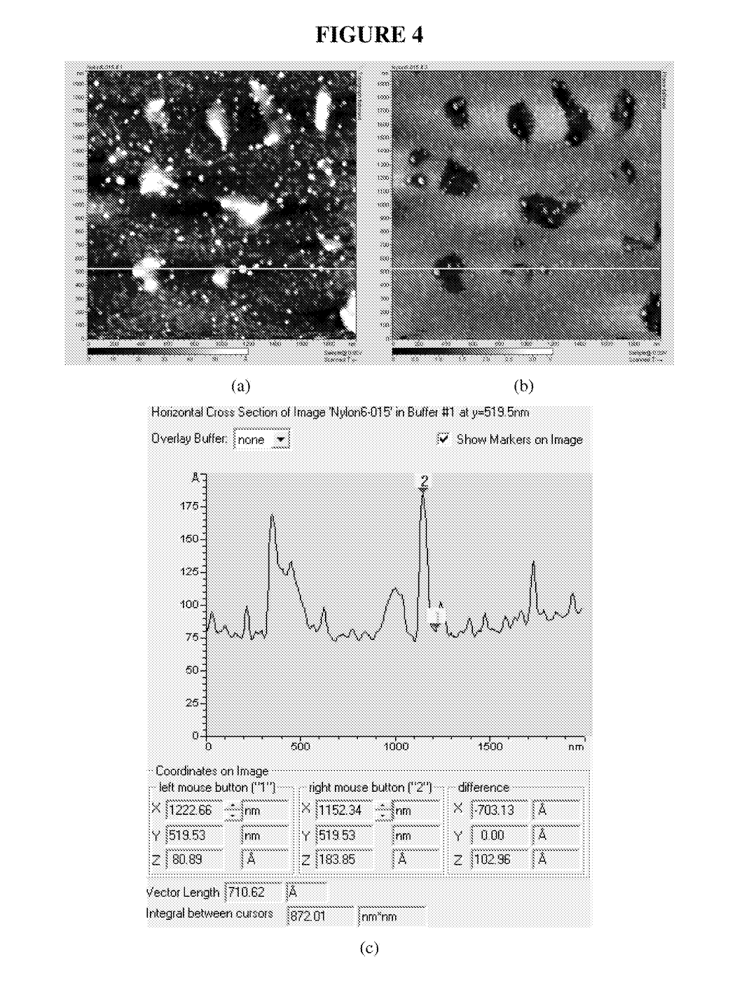

AFM images for the nylon-6 concentrations of 0.5 and 0.1 mg/mL (small scale) are shown in FIGS. 3 and 4, respectively. As shown in Table 1, the diameter of the nanoparticles formed using the 0.5 mg/mL sample, was approximately 10-20 nm, although some larger nanoparticles were observed in the height image (See FIG. 3(c)). Furthermore, the nanoparticles formed using this method were substantially spherical.

Nanoparticles formed using the 0.1 mg/mL sample (small scale) show a different morphology, (See FIG. 4). As shown in the height image, the shape of the nanostructures is not spherical. The large irregular flakes are likely aggregations of the surfactant. As shown in the phase image of FIG. 4(b), contrast between the surfactant flake structures and the tiny polymer nanoparticles were observed, which suggests that the fine nanoparticles were embedded in the surfactant aggregation. The fine nanoparticles were either freely dispersed in water or scattered in the surfactant aggregations, and the size of most of the nanoparticles is smaller than 10 nm (See Table 1).

Table 1 further provides the comparison between nanoparticle fabrication reactions run on the small and large scale. As shown in the table, the reaction scale can have a significant influence on the size of the nanoparticles formed. For example, when a formic acid solution contain 1 mg/mL of nylon-6 was added to an aqueous solution containing 0.045 mg/mL of Triton X-100, the particle size was in the range 70-80 nm on the small scale, and in the range of 4-8 nm on the large scale.

TABLE 1
Influence of nylon-6 concentration on the particle size for TX-100
solutions (small and large scale reactions)

| | | Size (nm) | Size (nm) |
|---|---|---|---|
| C_{Nylon} (mg/mL) | C_{X-100} (mg/mL) | Small Scale | Large Scale |
| 0.1 | 0.045 | <10 | — |
| 0.5 | 0.045 | 10-20 | — |
| 1 | 0.045 | 70-80 | 4-8 (mostly 5) |
| 5 | 0.45 | — | 10-20 (mostly 10) |
| 5 | 0.225 | Not Run | 1.5 |
| 5 | 0.045 | <10 | 7.5 (very uniform) |
| 10 | 0.225 | — | 2-5 (mostly 2.5) |
| 10 | 0.045 | — | 0.6-1.2 |
| 10 | 0.0225 | Not Run | — |
| 20 | 0.045 | Not Run | — |

### Example 2

### Nylon-6/Formic Acid Additions to Aqueous CTAB Solutions

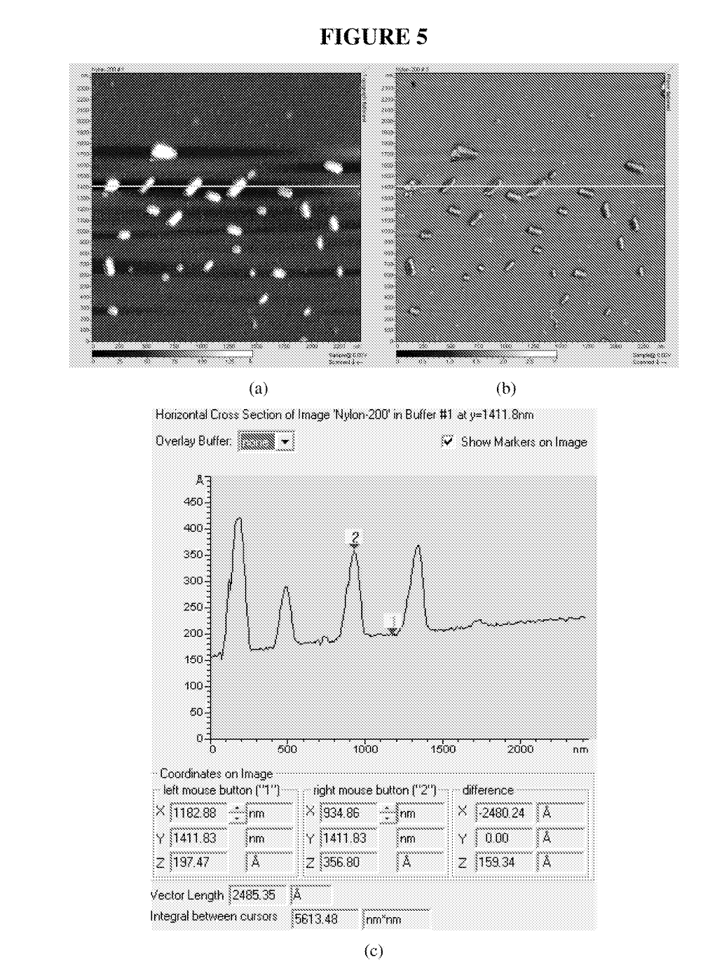

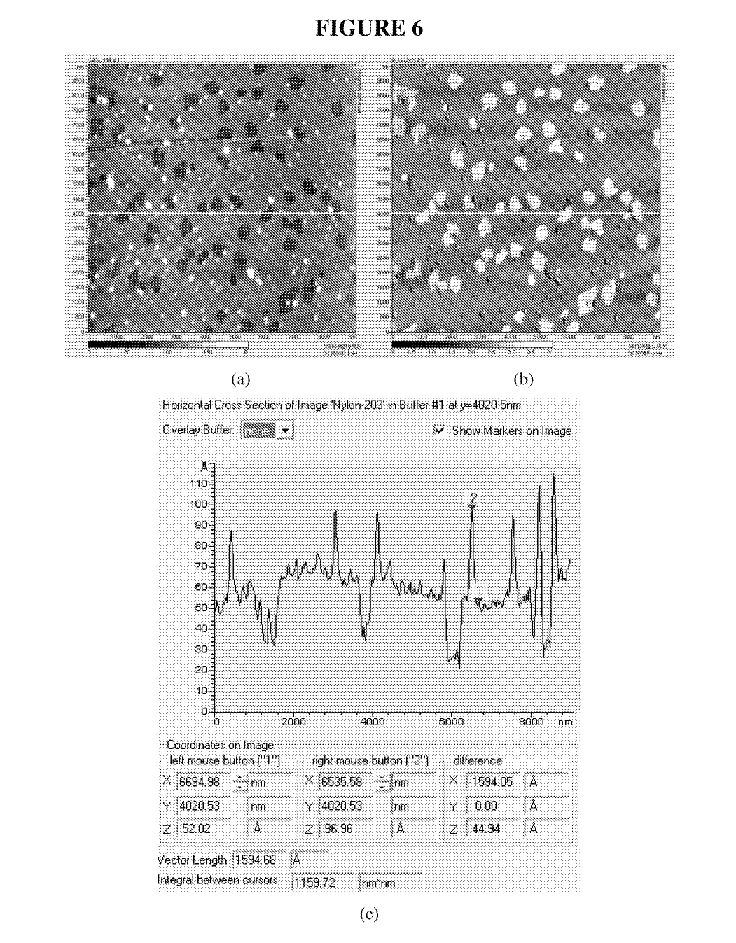

Two different nylon concentrations were used (1.0 mg/mL and 0.1 mg/mL) and the nanoparticles were formed and isolated according to the aforementioned general procedures. The morphological studies by AFM for the small scale nanoparticle fabrication reactions are shown in FIGS. 5 and 6.

At the 1 mg/mL nylon-6 concentration the fabricated nylon nanoparticles showed a nanorod morphology (See FIGS. 5(a) and (b), possibly due to the charge-dipole interaction between the polyamide and CTAB molecules. As shown in Table 2, the diameter of the nano-rods is in the 15-20 nm range. As a highly crystalline polymer, one-dimensional orientations, such as nylon fibers, are easily formed during the processing.

By 10 times diluting the nylon solution, another novel morphology was formed and shown in FIG. 6 Similar to the cases with TX-100, the surfactants formed aggregations and the fine nanoparticles were dispersed in the surfactant matrix or freely suspended in water. Different from the nano-rod morphology shown in FIG. 5, most of the fine nanoparticles are spherical in shape. In the phase image, FIG. 6(b), the contrast between the white flakes and the fine particles shows the hardness difference between nylon-6 and CTAB. Combining the section analysis, FIG. 6(c), the height image shows the diameter of the fine nanoparticles at about 5nm (See Table 2).

TABLE 2
Influence of Nylon concentration on the particle size for CTAB
solutions (small scale reactions)

| C_{Nylon} (mg/mL) | C_{CTAB} (mg/mL) | Size (nm) |
|---|---|---|
| 1 | 0.074 | 15-20 |
| 0.1 | 0.074 | ~5 |

The present invention is not limited in scope by the specific embodiments described herein. Indeed, various modifications of the invention in addition to those described herein will become apparent to those skilled in the art from the foregoing description and the accompanying figures. Such modifications are intended to fall within the scope of the appended claims. It is further to be understood that all values given in the foregoing examples are approximate, and are provided for purposes of illustration.

Patents, patent applications, publications, product descriptions, and protocols which are cited throughout this application are incorporated herein by reference in their entireties for all purposes. In case of conflict, the present specification controls.

### REFERENCES

1. Dasgupta, S.; Hammond, W. B.; Goddard, W. A., III, Crystal Structures and Properties of Nylon Polymers from Theory. J. Am. Chem. Soc. 1996, 118, (49), 12291-12301.
2. Baird, D. K., Nylon. Trans. Inst. Plastics Ind. 1945, 23-31.
3. Das, S.; Hollister, S. J.; Flanagan, C.; Adewunmi, A.; Bark, K.; Chen, C.; Ramaswamy, K.; Rose, D.; Widjaja, E., Freeform fabrication of Nylon-6 tissue engineering scaffolds. Rapid Prototyping Journal 2003, 9, (1), 43-49.
4. Meyer-Plath, A. A.; Schroder, K.; Finke, B.; Ohl, A., Current trends in biomaterial surface functionalization-nitrogen-containing plasma assisted processes with enhanced selectivity. Vacuum 2003, 71, (3), 391-406.
5. Li, W.-J.; Laurencin, C. T.; Caterson, E. J.; Tuan, R. S.; Ko, F. K., Electrospun nanofibrous structure: A novel scaffold for tissue engineering. Journal of Biomedical Materials Research 2002, 60, (4), 613-621.
6. Melton, D. W., Gene targeting in the mouse. Bioessays 1994, 16, 633-638.
7. Anderson, D. G.; Levenberg, S.; Langer, R., Nanoliter-scale synthesis of arrayed biomaterials and application to human embryonic stem cells. Nat Biotech 2004, 22, (7), 863-866.
8. Khor, H. L.; Ng, K. W.; Schantz, J. T.; Phan, T.-T.; Lim, T. C.; Teoh, S. H.; Hutmacher, D. W., Poly(□-caprolactone) films as a potential substrate for tissue engineering an epidermal equivalent. Materials Science and Engineering: C 2002, 20, (1-2), 71-75.
9. Deschamps, A. A.; van Apeldoorn, A. A.; de Bruijn, J. D.; Grijpma, D. W.; Feijen, J., Poly(ether ester amide)s for tissue engineering. Biomaterials 2003, 24, (15), 2643-2652.
10. Risbud, M. V.; Bhonde, R. R., Polyamide 6 composite membranes: Properties and in vitro biocompatibility evaluation. J. Biomater. Sci. Polymer Edn 2001, 12, (1), 125-136.
11. Bullett, N. A.; Bullett, D. P.; Truica-Marasescu, F.-E.; Lerouge, S.; Mwale, F.; Wertheimer, M. R., Polymer surface micropatterning by plasma and VUV-photochemical modification for controlled cell culture. Applied Surface Science 2004, 235, (4), 395-405.
12. Nelea, V.; Luo, L.; Demers, C. N.; Antoniou, J.; Petit, A.; Lerouge, S.; Wertheimer, M. R.; Mwale, F., Selective inhibition of type X collagen expression in human mesenchymal stem cell differentiation on polymer substrates surface-modified by glow discharge plasma. Journal of Biomedical Materials Research Part A 2005, 75A, (1), 216-223.
13. Schindler, M.; Ahmed, I.; Kamal, J.; Nur-E-Kamal, A.; Grafe, T. H.; Young Chung, H.; Meiners, S., A synthetic nanofibrillar matrix promotes in vivo-like organization and morphogenesis for cells in culture. Biomaterials 2005, 26, (28), 5624-5631.
14. Langer, R.; Vacanti, J. P., Tissue Engineering. Science 1993, 260, (5110), 920-926.
15. Wei, J.; Li, Y., Tissue engineering scaffold material of nano-apatite crystals and polyamide composite. European Polymer Journal 2004, 40, (3), 509-515.
16. Lavik, E.; Langer, R., Tissue engineering: current state and perspectives. Applied Microbiology and Biotechnology 2004, 65, (1), 1-8.
17. Griffith, L. G.; Naughton, G., Tissue Engineering--Current Challenges and Expanding Opportunities. Science 2002, 295, (5557), 1009-1014.
18. Urbach, A. R.; Dervan, P. B., Toward rules for 1:1 polyamide:DNA recognition. Proc. Natl Acad. Sci. USA 2001, 98, 4343-4348.
19. Brown, R. A.; Wiseman, M.; Chuo, C. B.; Cheema, U.; Nazhat, S. N.,

Ultrarapid Engineering of Biomimetic Materials and Tissues: Fabrication of Nano- and Microstructures by Plastic Compression. Adv. Functional Mater. 2005, 15, (11), 1762-1770.
20. Stephens, J. S.; Chase, D. B.; Rabolt, J. F., Effect of the Electrospinning Process on Polymer Crystallization Chain Conformation in Nylon-6 and Nylon-12. Macromolecules 2004, 37, (3), 877-881.
21. Crespy, D.; Landfester, K., Anionic Polymerization of □-Caprolactam in Miniemulsion: Synthesis and Characterization of Polyamide-6 Nanoparticles. Macromolecules 2005, 38, (16), 6882-6887.
22. Oliveira, A. P. A.; Hochepied, J. F.; Grillon, F.; Berger, M. H., Controlled

Precipitation of Zinc Oxide Particles at Room Temperature. Chem. Mater. 2003, 15, (16), 3202-3207.
23. Radtchenko, I. L.; Sukhorukov, G. B.; Gaponik, N.; Kornowski, A.; Rogach, A. L.; Möhwald, H., Core-Shell Structures Formed by the Solvent-Controlled Precipitation of Luminescent CdTe Nanocrystals on Latex Spheres. Adv. Mater. 2001, 13, (22), 1684-1687.
24. Izquierdo, M.; Davila, M. E.; Avila, J.; Ascolani, H.; Teodorescu, C. M.; Martin, M. G.; Franco, N.; Chrost, J.; Arranz, A.; Asensio, M. C., Epitaxy and Magnetic Properties of Surfactant-Mediated Growth of bcc Cobalt. Physical Review Letters 2005, 94, (18), 187601.
25. Peng, T.; Hasegawa, A.; Qiu, J.; Hirao, K., Fabrication of Titania Tubules with High Surface Area and Well-Developed Mesostructural Walls by Surfactant-Mediated Templating Method. Chem. Mater. 2003, 15, (10), 2011-2016.
26. Harada, M.; Adachi, M., Surfactant-Mediated Fabrication of Silica Nanotubes. Adv. Mater. 2000, 12, (11), 839-841.
27. Nuraje, N.; Su, K.; Haboosheh, A.; Samson, J.; Manning, E. P.; Yang, N. 1.; Matsui, H., Room Temperature Synthesis of Ferroelectric Barium Titanate Nanoparticles Using Peptide Nano-rings as Templates. Adv. Mater. 2006, 18, (6), 807-811.

What is claimed is:

1. A method for fabricating polymer nanostructures, which method comprises:
addition of a polymer solution including one or more solvents and one or more polymers to an aqueous solution including one or more surfactants, wherein
the concentration of the one or more surfactants in the aqueous solution is lower than the critical micelle concentration of the surfactants, and wherein
the addition of the polymer solution to the aqueous solution precipitates a plurality of polymer nanostructures.

2. The method of claim 1, wherein the one or more solvents of the polymer solution are miscible with water.

3. The method of claim 2, wherein the aqueous solution is stirred or agitated while the polymer solution is added.

4. The method of claim 2, wherein the plurality of polymer nanostructures are separated from a supertanant comprising the one or more solvents of the polymer solution and water.

5. The method of claim 1, wherein the polymer solution contains one or more polymers selected from the group consisting of polyamides, polyesters, polyethers, polyacrylates, and collagen.

6. The method of claim 5, wherein the polymer is a polyamide.

7. The method of claim 6, wherein the polyamide is nylon, or collagen, or mixtures thereof.

8. The method of claim 5, wherein the overall concentration of the one or more polymers in the polymer solution is from about 0.1 mg/mL to about 100 mg/mL.

9. The method of claim 5, wherein the one or more solvents comprises an acid, or a mixture of an acid and water.

10. The method of claim 9, wherein the solvent consists essentially of formic acid or formic acid and water.

11. The method of claim 1, wherein the one or more surfactants is selected from the group consisting of non-ionic surfactants, cationic surfactants, and anionic surfactants.

12. The method of claim 11, wherein the surfactant is cetyl ammonium bromide, Triton X-100, polyoxyethylene Octyl phenyl ether, or mixtures thereof.

13. The method of claim 12 wherein the overall concentration of surfactant in the aqueous solution is from about 0.02 mg/mL to about 0.5 mg/mL.

14. A plurality of polymer nanostructures prepared by the method of claim 1.

15. The nanostructures of claim 14, wherein the nanostructures are in the form of nanoparticles.

16. The nanoparticles of claim 15, wherein the nanoparticles have a size of from about 5 nm to about 500 nm

17. The nanoparticles of claim 16, wherein the nanoparticles are substantially uniform in size.

18. The nanoparticles of claim 16, wherein the nanoparticles are of regular shape.

19. The nanoparticles of claim 18, wherein the shape of the nanoparticles is spherical, spheroidal, or rod-like.

20. The method of claim 1, wherein the concentration of the one or more surfactants in the aqueous solution is from about 2 times to about 200 times lower than the critical micelle concentration of the surfactants.

21. The method of claim 21, wherein the concentration of the one or more surfactants in the aqueous solution is from about 10 times to about 100 times lower than the critical micelle concentration of the surfactants.
